(19) United States
(12) Patent Application Publication
(10) Pub. No.: US 2010/0001945 A1
(43) Pub. Date: Jan. 7, 2010

(54) DRIVING METHOD OF LIQUID CRYSTAL DISPLAY

(76) Inventors: Chi-Hsiu Lin, Yun-Lin Hsien (TW); Shih-Chieh Yen, Chiayi County (TW); Ming-Chang Lin, Tainan County (TW); Chia-Chun Fang, Kaohsiung City (TW)

Correspondence Address: NORTH AMERICA INTELLECTUAL PROPERTY CORPORATION, P.O. BOX 506, MERRIFIELD, VA, 22116, US

(21) Appl. No.: 12/345,651

(22) Filed: Dec. 29, 2008

(30) Foreign Application Priority Data
Jul. 3, 2008 (TW) 097125049

(51) Int. Cl. G09G 3/36

(52) U.S. Cl. 345/102

(57) ABSTRACT

A driving method of an LCD includes: dividing a display panel into a plurality of scanning blocks, each scanning block including a plurality of display regions; selecting one of the scanning blocks as a target scanning block, wherein each display region of the target scanning block corresponds to at least one backlight source; and selecting one of the display regions of the target scanning block as a target display region, detecting a gray value of an image of the target display region, and adjusting a luminance of a target backlight source corresponding to the target display region according to the gray value of the image.

### BACKGROUND OF THE INVENTION

1. Field of the Invention

The present invention relates to a driving method of a liquid crystal display (LCD), and more particularly, to a driving method of an LCD having a scanning light-emitting diode (LED) backlight module.

2. Description of the Prior Art

Due to luminance of a conventional backlight module of an LCD being fixed and unvaried with time, a “motion blur” phenomenon easily occurs and the quality of the displayed image is thereby degraded. A scanning backlight module and related method have been developed to solve this problem. FIG. 1 is a diagram illustrating a prior art LCD having the scanning backlight module. As shown in FIG. 1, an LCD panel 110 includes three scanning blocks 112, 114, 116, each scanning block corresponding to its own lamp 120. A driving method of the prior art LCD having the scanning backlight module is described as follows: during a first driving period, the lamps 120a and 120b corresponding to the scanning block 112 are turned on and the other lamps are turned off; during a second driving period, the lamps 120c and 120d corresponding to the scanning block 114 are turned on and the other lamps are turned off; and during a third driving period, the lamps 120e and 120f corresponding to the scanning block 116 are turned on and the other lamps are turned off; then, the above operations of the lamps are repeated. For each scanning block, the corresponding lamps being turned off during a frame time is like inserting a black image between two frames, and therefore the “motion blur” phenomenon is improved.

In the above-mentioned driving method of the LCD having the scanning backlight module, as all the lamps 120 are not turned-on at the same time, the overall luminance of the LCD is lower than that of the LCD having the conventional backlight module. As shown in FIG. 1, the overall luminance of the LCD having the scanning backlight module is about one-third of the overall luminance of the LCD having the conventional backlight module, and a power consumption of the scanning backlight module is also about one-third of the conventional backlight module.

A solution for the degraded overall luminance of the LCD having the scanning backlight module is to increase the luminance of each lamp 120. Increasing the luminance of the lamp 120, however, means that the lamp 120 must be driven by a higher voltage or have a higher current, causing the lifetime of the lamp to be decreased.

### SUMMARY OF THE INVENTION

It is therefore an objective of the present invention to provide a driving method of an LCD having LED backlight sources, to solve the above-mentioned problem.

According to one embodiment of the present invention, a driving method of an LCD includes: dividing a display panel into a plurality of scanning blocks, each scanning block including a plurality of display regions; selecting one of the scanning blocks as a target scanning block, wherein each display region of the target scanning block corresponds to at least one backlight source; selecting one of the display regions of the target scanning block as a target display region, and detecting a gray value of an image of the target display region, and adjusting a luminance of a target backlight source corresponding to the target display region according to the gray value of the image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a prior art LCD having the scanning backlight module.

FIG. 2 is a diagram illustrating an LCD having a scanning backlight module according to one embodiment of the present invention.

FIG. 3 is a diagram illustrating the luminance of the display regions of the LCDs having the scanning backlight modules respectively shown in FIG. 1 and FIG. 2.

FIG. 4 is a diagram illustrating a flowchart of adjusting the luminance of the backlight source.

### DETAILED DESCRIPTION

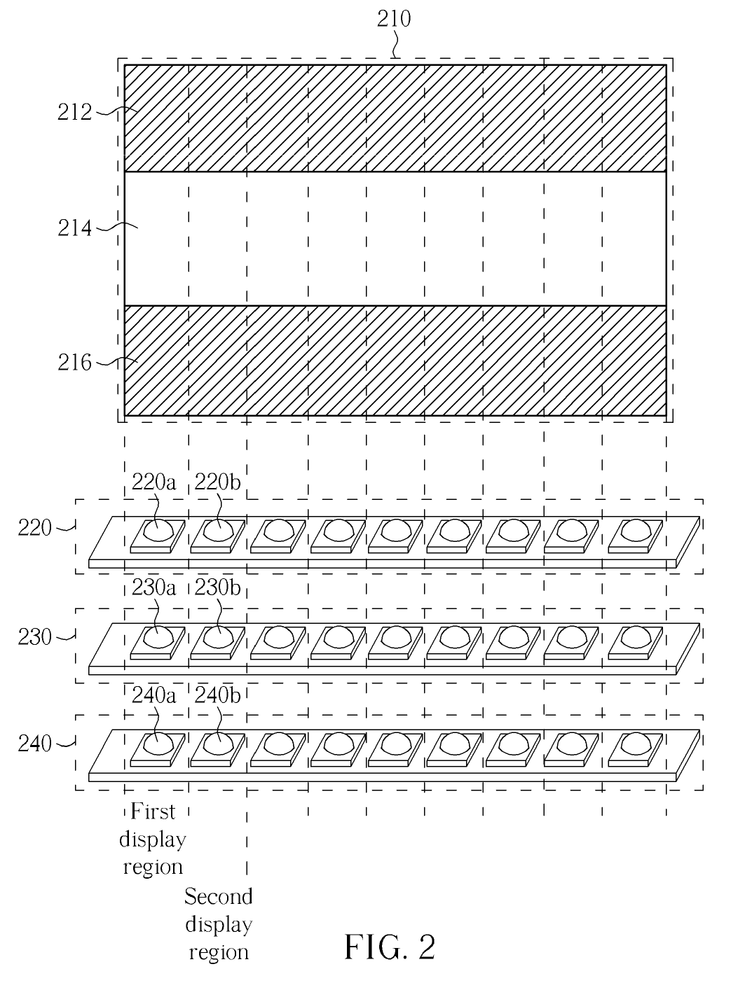

Please refer to FIG. 2. FIG. 2 is a diagram illustrating an LCD having a scanning backlight module according to one embodiment of the present invention. As shown in FIG. 2, an LCD panel 210 includes three scanning blocks 212, 214, and 216 that respectively correspond to groups of LEDs 220, 230, and 240, where each scanning block is divided into a plurality of display regions. In addition, each display region corresponds to its own LED, for example, first display regions of the scanning blocks 212, 214, and 216 respectively correspond to LEDs 220a, 230a, and 240a, and second display regions of the scanning blocks 212, 214, and 216 respectively correspond to LEDs 220b, 230b, and 240b. The luminance of each LED is adjustable.

The driving method of the LCD having a scanning backlight module of the present invention is described as follows: during a first driving period, the LEDs 220 are enabled, and the LEDs 230 and 240 are disabled. In addition, there is a positive correlation between a maximum gray value of an image of the display region and the luminance of its corresponding LED 220. For example, assuming that the maximum gray value of the first display region of the scanning block 212 is equal to a value 200, the luminance of the LED 212a is adjusted to ensure that the first display region can display the image having correct gray values; that is, the gray value 200 can be correctly shown. Assuming that the maximum gray value of the second display region of the scanning block 212 is equal to a value 100, the luminance of the LED 212b is adjusted to ensure that the second display region can display the image having correct gray values. According to the above descriptions, the greater the maximum gray value of the image of the display region, the greater luminance of the corresponding LED; that is, there is a positive correlation between the maximum gray value of the image of the display region and the luminance of its corresponding LED.

During a second driving period, the LEDs 230 are enabled, and the LEDs 220 and 240 are disabled. The method of luminance-adjustments of the display region of the scanning block 214 is similar to that of the scanning block 212; that is, there is a positive correlation between a maximum gray value of an image of the first display region of the scanning block 214 and the luminance of its corresponding LED 230a, and a positive correlation between a maximum gray value of an image of the second display region of the scanning block 214 and the luminance of its corresponding LED 230b. Then, during a third driving period, the LEDs 240 are enabled, and the LEDs 220 and 230 are disabled. The method of luminance-adjustments of the display region of the scanning block 216 is similar to that of the scanning block 212; that is, there is a positive correlation between a maximum gray value of an image of the first display region of the scanning block 216 and the luminance of its corresponding LED 240a, and a positive correlation between a maximum gray value of an image of the second display region of the scanning block 216 and the luminance of its corresponding LED 240b. Then, the luminance-adjusting method of the above three periods are repeated. In addition, in this embodiment, the first, second, and third driving period are continuous periods.

It is noted that the LCD having the scanning backlight module shown in FIG. 2 is merely an example, and quantities of the scanning blocks, the display regions, and the LEDs corresponding to one display region can be designed according to the designer's considerations, and these alternative designs also fall within the scope of the present invention.

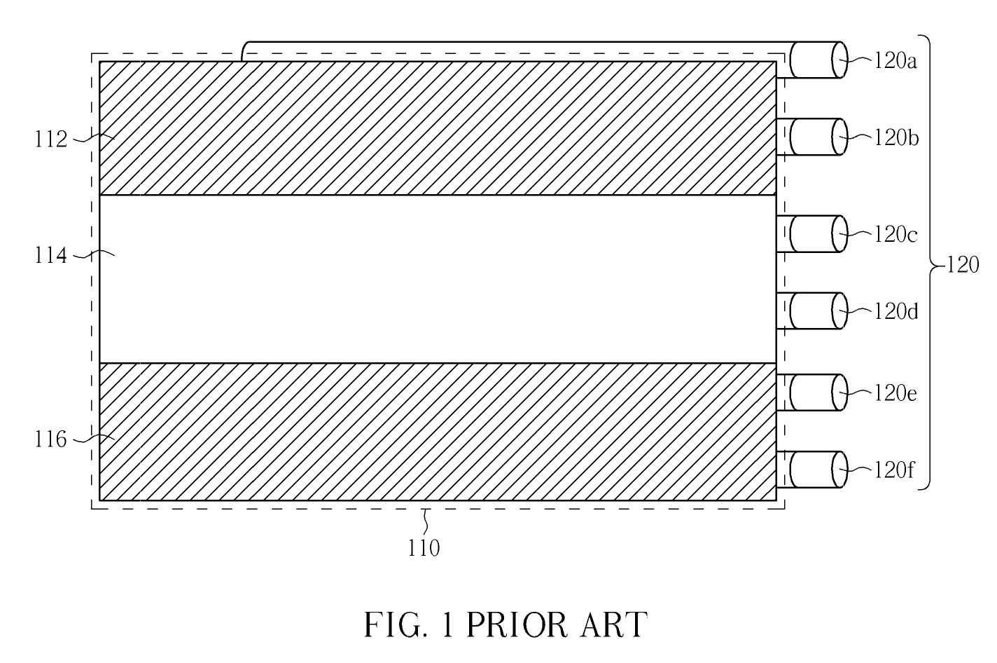

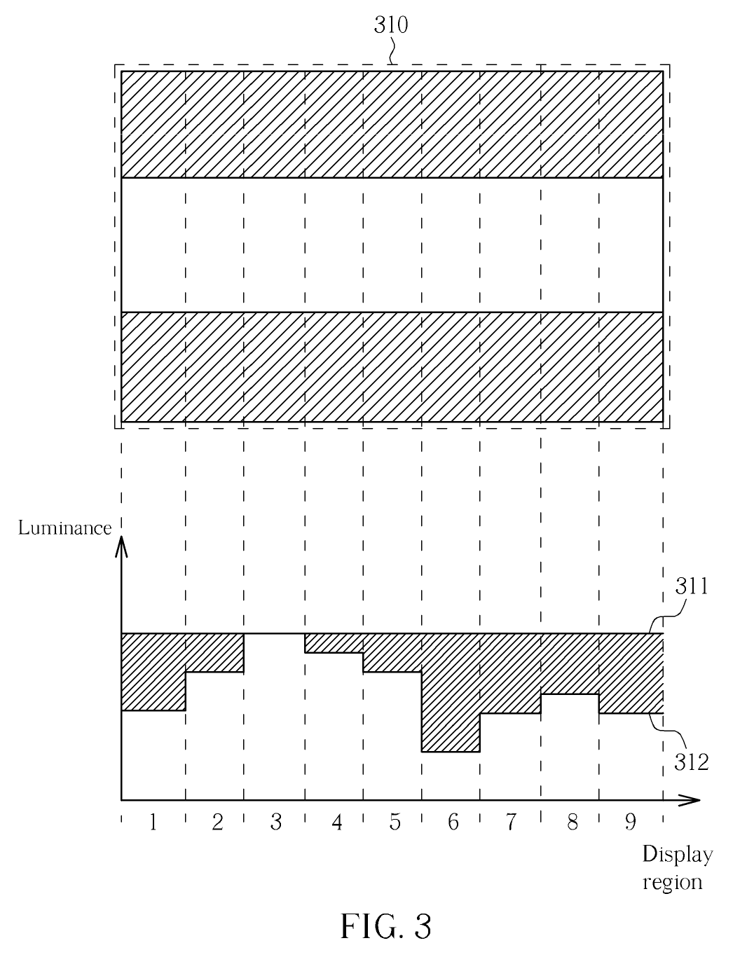

Please refer to FIG. 3. FIG. 3 is a diagram illustrating the luminance of the display regions of the LCDs having the scanning backlight modules respectively shown in FIG. 1 and FIG. 2. As shown in FIG. 3, for a same scanning block, a line 311 represents the luminance of the display regions of the prior art LCD shown in FIG. 1, and a line 312 represents the luminance of the display regions of the LCD of the present invention shown in FIG. 2. The shadow area shown in FIG. 3 represents differences between the line 311 and 312, and also represents a power consumption difference between the LCDs shown in FIG. 1 and FIG. 2. As a result, the LCD having the scanning backlight module of the present invention does indeed lower the power consumption of the backlight module.

Because the overall luminance of the LCD is degraded by using the scanning backlight module, the luminance of each backlight source needs to be increased to improve this issue. If the lamps serve as the backlight sources, the luminance of the lamps need to be increased by increasing the current of the lamps, therefore causing shorter lifetimes of the lamps. If the LEDs serve as the backlight sources, because the lifetime of the LED is proportional to a product of the luminance and an enabling time of the LED, and because the enabling time of each LED shown in FIG. 2 is one-third of the original, the luminance of the LED can be doubled or tripled without shortening the lifetime of the LED.

In addition, as shown in FIG. 2, because the luminance of the LEDs 220, 230, 240 vary according to the gray values of the images of the display regions, respectively, “dynamic contrast” of the LCD can therefore be improved.

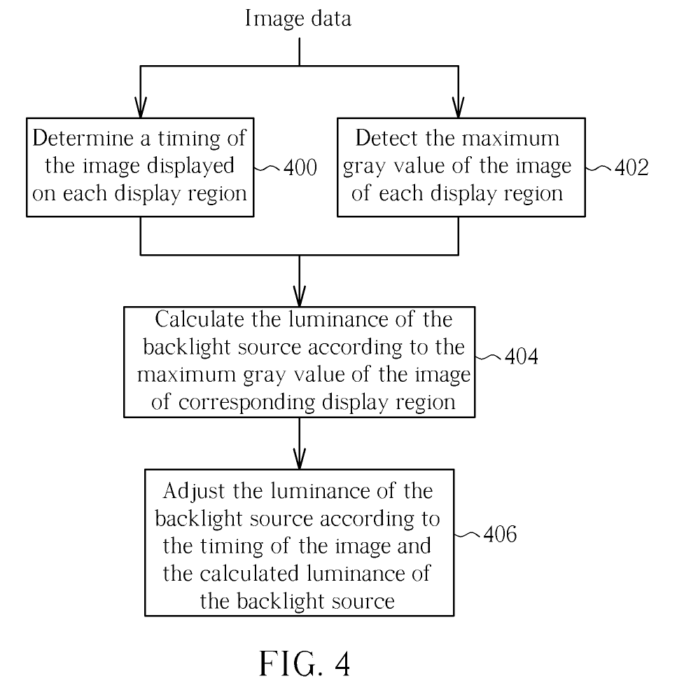

Please refer to FIG. 4. FIG. 4 is a diagram illustrating a flowchart of adjusting the luminance of the backlight source. The steps are described as follows:

Step 400: Determine a timing of the image displayed on each display region;

Step 402: Detect the maximum gray value of the image of each display region;

Step 404: Calculate the luminance of the backlight source according to the maximum gray value of the image of corresponding display region;

Step 406: Adjust the luminance of the backlight source according to the timing of the image and the calculated luminance of the backlight source.

It is noted that, because the operations of the LCD having the scanning backlight module of the present invention are described in the above paragraphs related to FIG. 2, detailed descriptions of the operations in FIG. 4 are omitted here.

Briefly summarizing the driving method of the LCD of the present invention, first, a display panel is divided into a plurality of scanning blocks, where each scanning block includes a plurality of display regions; then, one of the scanning blocks is selected as a target scanning block, where each display region of the target scanning block corresponds to at least one backlight source; then, one of the display regions of the target scanning block is selected as a target display region, and a gray value of an image of a target display region is detected; and finally, a luminance of a backlight source corresponding to the target display region is adjusted according to the gray value of the image.

Those skilled in the art will readily observe that numerous modifications and alterations of the device and method may be made while retaining the teachings of the invention.

What is claimed is:

1. A driving method of a liquid crystal display (LCD), comprising:
dividing a display panel into a plurality of scanning blocks, each scanning block including a plurality of display regions;
selecting one of the scanning blocks as a target scanning block, wherein each display region of the target scanning block corresponds to at least one backlight source; and
selecting one of the display regions of the target scanning block as a target display region, detecting a gray value of an image of the target display region, and adjusting a luminance of a target backlight source corresponding to the target display region according to the gray value of the image.

2. The driving method of claim 1, wherein the backlight source is a light-emitting diode (LED).

3. The driving method of claim 1, wherein the display panel is a liquid crystal display panel.

4. The driving method of claim 1, wherein the step of detecting the gray value of the image of the target display region comprises:
detecting a maximum gray value of the image of the target display region.

5. The driving method of claim 4, wherein the step of adjusting the luminance of the target backlight source corresponding to the target display region according to the gray value of the image comprises:
adjusting the luminance of the target backlight source according to a positive correlation between the luminance of the target backlight source and the maximum gray value of the image of the target display region.

6. The driving method of claim 1, wherein the step of adjusting the luminance of the target backlight source corresponding to the target display region according to the gray value of the image comprise:
determining a timing of the image of the target display region;
calculating the luminance of the target backlight source according to the gray value of the image of the target display region; and
adjusting the luminance of the backlight source according to the timing of the image and the calculated luminance of the target backlight source.
